(19) United States
(12) Patent Application Publication
(10) Pub. No.: US 2019/0118395 A1
(43) Pub. Date: Apr. 25, 2019

(54) FOLDING KNIFE CONFIGURED FOR PRECISE AND RAPID DISASSEMBLY AND REASSEMBLY

(71) Applicant: KANTAS PRODUCTS CO., LTD., Taipei City (TW)

(72) Inventor: Yang-Fu CHENG, Taipei City (TW)

(73) Assignee: KANTAS PRODUCTS CO., LTD., Taipei City (TW)

(21) Appl. No.: 15/989,245

(22) Filed: May 25, 2018

(30) Foreign Application Priority Data
Oct. 20, 2017 (TW) 106136102

(51) Int. Cl. B26B 1/04; B26B 5/00; B26B 1/10

(52) U.S. Cl. CPC B26B 1/044; B26B 1/10; B26B 5/00

(57) ABSTRACT

A folding knife configured for precise and rapid disassembly and reassembly includes two pivotally connecting and engaging shafts fixedly provided on a first- and a second-side handle portion respectively. The shafts are pivotally connectable and mutually engageable so that the handle portions and a blade can be rapidly and precisely put together, allowing the blade to rotate with respect to the handle portions about an axis defined by the shafts either into or out of the space between the handle portions. The folding knife further includes two locking members provided on the handle portions respectively. The locking members can be locked together to connect the blade to the handle portions securely. By pushing one of the locking members, the locking members can be unlocked from each other to enable disengagement between the shafts and hence rapid and complete separation between the blade and the handle portions.

### FIELD OF THE INVENTION

The present invention relates to a folding knife. More particularly, the invention relates to a folding knife with a first pivotally connecting and engaging shaft and a second pivotally connecting and engaging shaft fixedly provided on a first-side handle portion and a second-side handle portion respectively so that a blade can be rapidly and precisely connected to the first- and the second-side handle portions through pivotal connection and engagement between the first and the second pivotally connecting and engaging shafts, and be rotated with respect to the first- and the second-side handle portions about an axis defined by the first and the second pivotally connecting and engaging shafts either into or out of a storage space formed between the first- and the second-side handle portions.

### BACKGROUND OF THE INVENTION

Commercially available folding knives are typically composed of a handle and a blade, wherein the blade is pivotally connected to the handle in order to be rotated about the pivot joint and thereby moved out of or stored into the handle. Such a folding knife can be carried around both easily and safely because it is compact in size and has the blade stored in the handle when folded. Compared with their non-foldable counterparts, therefore, folding knives are far more convenient for divers, outdoor enthusiasts, soldiers, police officers, and so forth.

However, a folding knife that has been used for a long time tends to have a buildup of grime in the handle, in addition to a blunt blade. This is why a folding knife must be disassembled after each relatively long period of use so that the grime can be removed and the blade taken out for grinding and polishing to restore the performance of the folding knife. Besides, in order to ensure steady use by its users, a folding knife is generally so designed that its blade is pivotally connected between two plates, and that the plates are subsequently put together and secured with screws or other elements to form a handle. While this conventional manufacturing method can keep the handle and the blade of a folding knife from separating from each other due to an external force during use, the same method adds to the difficulty of disassembly, and hence maintenance, of the folding knife.

As a solution, improvements have been made to the folding knife structure. For example, U.S. Pat. No. 9,586,328 B2, assigned to GB II Corporation of US, discloses an easily disassembled folding knife 800 as briefly described below with reference to FIG. 1 to FIG. 5. The folding knife 800 is composed of a first-side handle portion 806, a second-side handle portion 808, a blade 804, and a locking portion 840. The inner side of the second-side handle portion 808 is protrudingly provided with a pivotally connecting post 834 adjacent to one end of the second-side handle portion 808. The top side of the pivotally connecting post 834 is protrudingly provided with a first block 838. The junction between the first block 838 and the pivotally connecting post 834 is recessed to form a first engaging groove 836. The first block 838 is rectangular (or non-circular) and is protrudingly provided on the top side of the pivotally connecting post 834 in a tilted manner (see FIG. 3). The blade 804 is formed with a pivotally connecting hole 850 adjacent to one end of the blade 804. The pivotally connecting post 834 is configured to extend into the pivotally connecting hole 850 so that the blade 804 can rotate about an axis defined by the pivotally connecting post 834. The locking portion 840 has one end pivotally connected to the inner side of the second-side handle portion 808 at a position adjacent to the opposite end of the second-side handle portion 808. The top side of the locking portion 840 is protrudingly provided with a second block 846 adjacent to the aforesaid end of the locking portion 840. The second block 846 is also rectangular (or non-circular) and is configured to rotate along with the locking portion 840. The junction between the second block 846 and the locking portion 840 is also recessed to form a second engaging groove 844. The first-side handle portion 806 is formed with a first opening 818 adjacent to one end of the first-side handle portion 806 and a second opening 820 adjacent to the opposite end of the first-side handle portion 806. The first opening 818 and the second opening 820 are rectangular (or non-circular) and match the first block 838 and the second block 846 respectively in configuration. The first-side handle portion 806 is further protrudingly provided with two first engaging blocks 822 and two second engaging blocks 824. The first engaging blocks 822 correspond to two wall portions of the first opening 818 respectively and extend toward the first opening 818. The second engaging blocks 824 correspond to two wall portions of the second opening 820 respectively and extend toward the second opening 820.

With continued reference to FIG. 1 to FIG. 5, the folding knife 800 is assembled as follows. To begin with, the first-side handle portion 806 must be placed at a specific angle with respect to the second-side handle portion 808 such that the first opening 818 in the first-side handle portion 806 corresponds to the first block 838 on the second-side handle portion 808 (see FIG. 4). Next, the first block 838 is inserted through the first opening 818, and the locking portion 840 is rotated until the second block 846 thereon is oriented as shown in FIG. 4. Please note that the first engaging blocks 822 corresponding to the first opening 818 are now aligned with the first engaging groove 836 between the pivotally connecting post 834 and the first block 838, making it possible to rotate the first-side handle portion 806. The first-side handle portion 806 is subsequently rotated in order for the second opening 820 in the first-side handle portion 806 to correspond to the second block 846 on the second-side handle portion 808, and for the first block 838 to correspond no more to the first opening 818. After that, the second block 846 is inserted through the second opening 820 and thereby brings the second engaging blocks 824 corresponding to the second opening 820 into alignment with the second engaging groove 844 between the locking portion 840 and the second block 846. The locking portion 840 is then rotated again such that the second block 846, too, corresponds no more to the second opening 820. The first engaging blocks 822 and the second engaging blocks 824 are now engaged with the blocks 838, 846 respectively (see FIG. 1); as a result, the blade 804, the first-side handle portion 806, and the second-side handle portion 808 are put together as shown in FIG. 5 and FIG. 1. The blade 804 in this state can be rotated with respect to the first-side handle portion 806 and the second-side handle portion 808 about the axis defined by the pivotally connecting post 834 so as to be stored in a storage space formed between the first-side handle portion 806 and the second-side handle portion 808 (see FIG. 5) or be out of the storage space (see FIG. 1).

By the same token, referring to FIG. 2 to FIG. 4, disassembly of the folding knife 800 begins by rotating the locking portion 840 so that the second block 846 thereon corresponds to the second opening 820. Then, the first-side handle portion 806 or the second-side handle portion 808 is rotated until the first opening 818 corresponds to the first block 838, and only then can the folding knife 800 be dismantled by removing the first-side handle portion 806, the second-side handle portion 808, and the blade 804 in turn, with a view to cleaning or maintaining the aforesaid components or replacing the blade 804.

According to the above, the folding knife 800 (or a similar structure or mechanism) does allow rapid disassembly and reassembly by its users, but the following issues arise during use, as can be easily found by any user:

(1) While disassembling or reassembling the folding knife 800, a user must sequentially and repeatedly adjust the first-side handle portion 806, the second-side handle portion 808, and the locking portion 840 to their respective required positions with precision. The adjustment complicates the disassembly and reassembly of the folding knife 800 and therefore causes trouble to the user.

(2) The blocks 838, 846 and the openings 818, 820 are not circular but have specific polygonal shapes. These structural features require precision machining during manufacture and hence incur high machining costs. In addition, one who tries to disassemble or reassemble the folding knife 800 must adjust the positions of the blocks 838, 846 and of the corresponding openings 818, 820 very carefully because the blocks 838, 846 cannot be inserted through the openings 818, 820 respectively unless the former are aligned with the latter. Undoubtedly, the time-consuming and difficult aligning process makes it difficult to disassemble and reassemble the folding knife 800.

(3) The thicknesses of the engaging blocks 822, 824 must be equal to or slightly smaller than the depths of the engaging grooves 836, 844 respectively in order for the engaging blocks 822, 824 to engage respectively with the engaging grooves 836, 844 and thereby bring about a locked state after the first-side handle portion 806, the second-side handle portion 808, and the locking portion 840 are rotated. It is consequently required that the manufacturing tolerances of the related components of the folding knife 800 be controlled within a very small range; otherwise, either the folding knife 800 may have problem being assembled, or the components may get loose or make noise after the folding knife 800 is forced into the assembled state, resulting in a high fraction defective corrigible only through precision machining. Such machining, however, leads to high production cost and may thus hinder the popularization of the folding knife 800 and similar products that feature easy disassembly and reassembly.

(4) While the folding knife 800 is being disassembled or reassembled, friction and compression between the edges of the engaging blocks 822, 824 and the edges of the engaging grooves 836, 844 are inevitable. After long-term use, therefore, the edges of the engaging blocks 822, 824 or of the engaging grooves 836, 844 are bound to be damaged or deformed. Once the damage or deformation aggravates over time, engagement between the engaging blocks 822, 824 and the engaging grooves 836, 844 may become impossible, and in that case, the folding knife 800 can no longer be disassembled and reassembled as designed.

(5) The folding knife 800 is so configured that only after the blocks 838, 846 and the corresponding openings 818, 820 are adjusted precisely to the correct corresponding positions can the blocks 838, 846 be inserted through the openings 818, 820 respectively. If the folding knife 800 is of a relatively small size, the blocks 838, 846 and the corresponding openings 818, 820 will be, too, making it more difficult to align the blocks 838, 846 with the openings 818, 820 respectively, and the difficulty of assembling the folding knife 800 will increase significantly as a result.

As stated above, the conventional folding knives do have a large number of problems and drawbacks to be overcome. It is therefore an important issue for folding knife designers and manufacturers to design a novel folding knife whose components are simpler in structure and interconnection than before, and which consequently can be disassembled and reassembled faster and more easily and be safer and more convenient to use than its prior art counterparts.

### BRIEF SUMMARY OF THE INVENTION

In view of the aforementioned problems and drawbacks of the conventional folding knives that are designed to be disassembled and reassembled by users, the inventor of the present invention incorporated years of practical experience in the design, machining, and manufacture of knives and the notion of persistent improvement into extensive research and experiment and finally succeeded in developing a folding knife that can be precisely and rapidly disassembled and reassembled. The invention is intended to overcome all the foregoing problems and drawbacks and provide greater convenience and safety of use than conventionally achievable.

One objective of the present invention is to provide a folding knife configured for precise and rapid disassembly and reassembly. The folding knife includes a first-side handle portion, a first pivotally connecting and engaging shaft, a second-side handle portion, a second pivotally connecting and engaging shaft, a blade, a first locking member, and a second locking member. One end of the first pivotally connecting and engaging shaft is fixed on the inner side of the first-side handle portion at a position adjacent to a first end of the first-side handle portion. The opposite second end of the first pivotally connecting and engaging shaft is formed with a first pivot shaft. The first pivot shaft is adjacent to the end edge of the second end of the first pivotally connecting and engaging shaft and is protrudingly provided with a tenon that extends in a radial direction of the first pivot shaft. One end of the second pivotally connecting and engaging shaft is fixed on the inner side of the second-side handle portion at a position not only adjacent to a first end of the second-side handle portion but also corresponding to the first pivotally connecting and engaging shaft. The opposite end of the second pivotally connecting and engaging shaft is concavely provided with a first pivotally connecting groove that extends in the axial direction of the second pivotally connecting and engaging shaft. The wall of the first pivotally connecting groove is concavely provided with an engaging groove. The first pivot shaft and the tenon match the first pivotally connecting groove and the engaging groove respectively in configuration so that the first pivot shaft can be pivotally connected in the first pivotally connecting groove and the tenon can be engaged with the engaging groove to connect the first pivotally connecting and engaging shaft with the second pivotally connecting and engaging shaft, thereby putting together the first-side handle portion and the second-side handle portion rapidly and precisely, forming a storage space between the inner sides of the first-side handle portion and of the second-side handle portion. The blade has a first end formed with a blade tip. The blade is also formed with a pivotally connecting hole adjacent to the opposite second end of the blade. The pivotally connecting hole matches the second pivotally connecting and engaging shaft in configuration so as to be mounted around the outer periphery of the second pivotally connecting and engaging shaft such that the blade is connected to the first-side handle portion and the second-side handle portion and can be rotated with respect to the first-side handle portion and the second-side handle portion about an axis defined by the first pivotally connecting and engaging shaft and the second pivotally connecting and engaging shaft either into or out of the storage space. The first locking member is fixedly (or movably) mounted on the inner side of the first-side handle portion at a position adjacent to the opposite second end of the first-side handle portion. The second locking member is movably (or fixedly) mounted on the inner side of the second-side handle portion at a position adjacent to the opposite second end of the second-side handle portion. The second locking member matches the first locking member in configuration so that, once the blade, the first-side handle portion, and the second-side handle portion are put together, the first locking member and the second locking member can be locked together. One of the first locking member and the second locking member can be pushed to unlock the first locking member and the second locking member from each other, thereby allowing the first-side handle portion and the second-side handle portion to be rotated with respect to each other to disengage the first pivotally connecting and engaging shaft and the second pivotally connecting and engaging shaft from each other, making it possible to separate the blade, the first-side handle portion, and the second-side handle portion rapidly and completely from one another. The folding knife, therefore, can be cleaned much more conveniently and used far more stably and safely than its conventional counterparts.

### BRIEF DESCRIPTION OF THE SEVERAL VIEWS OF THE DRAWINGS

The objectives, technical features, and effects of the present invention can be better understood by referring to the following detailed description in conjunction with the accompanying drawings, in which:

FIG. 1 shows a conventional folding knife in an assembled state;

FIG. 2 shows the conventional folding knife in FIG. 1 in another assembled state;

FIG. 3 shows the conventional folding knife in FIG. 2 in a disassembled state;

FIG. 4 shows the conventional folding knife in FIG. 2 in a partially assembled state;

FIG. 5 shows the conventional folding knife in FIG. 2 in the fully folded state, with the first-side handle portion removed;

FIG. 6 is an exploded perspective view of the folding knife according to the first preferred embodiment of the present invention;

FIG. 7 shows the folding knife in FIG. 6 in a partially assembled state;

FIG. 8 is a perspective view of the first pivotally connecting and engaging shaft in the folding knife of the first preferred embodiment;

FIG. 9 is a perspective view of the second pivotally connecting and engaging shaft in the folding knife of the first preferred embodiment;

FIG. 10 shows the first pivotally connecting and engaging shaft in FIG. 8 and the second pivotally connecting and engaging shaft in FIG. 9 in a pivotally connected and engaged state;

FIG. 11 shows the folding knife in FIG. 6 in another partially assembled state;

FIG. 12 shows the folding knife in FIG. 6 in an assembled state;

FIG. 13 shows the first locking member and the second locking member in the folding knife of the first preferred embodiment in the locked state;

FIG. 14 shows the first locking member and the second locking member in FIG. 13 in the unlocked state;

FIG. 15 shows the third locking member and the fourth locking member in the folding knife of the second preferred embodiment of the invention in the locked state; and

FIG. 16 shows the third locking member and the fourth locking member in FIG. 15 in the unlocked state.

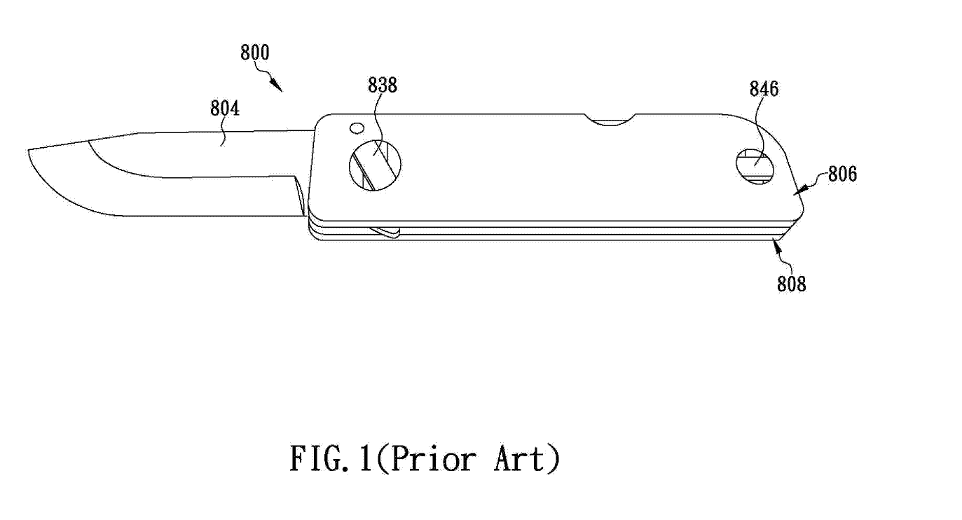

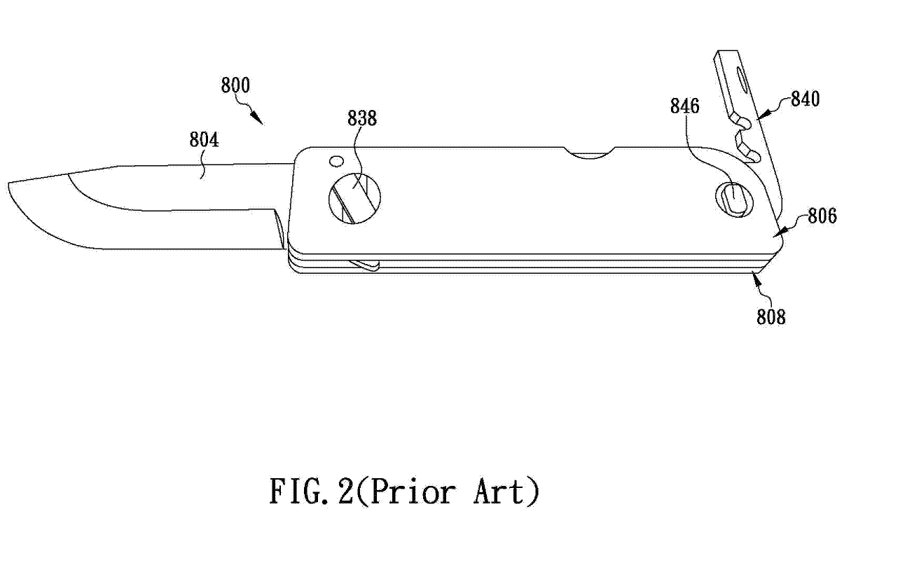

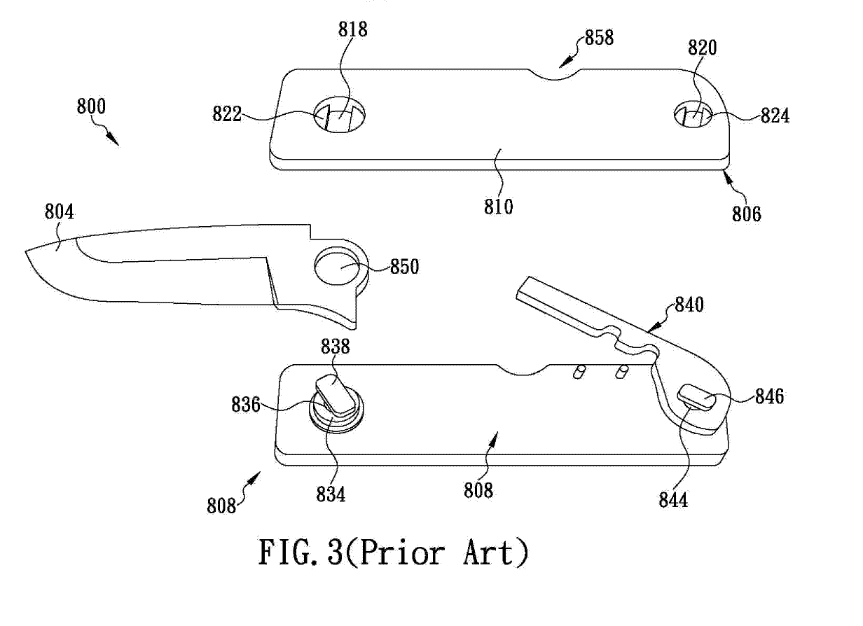

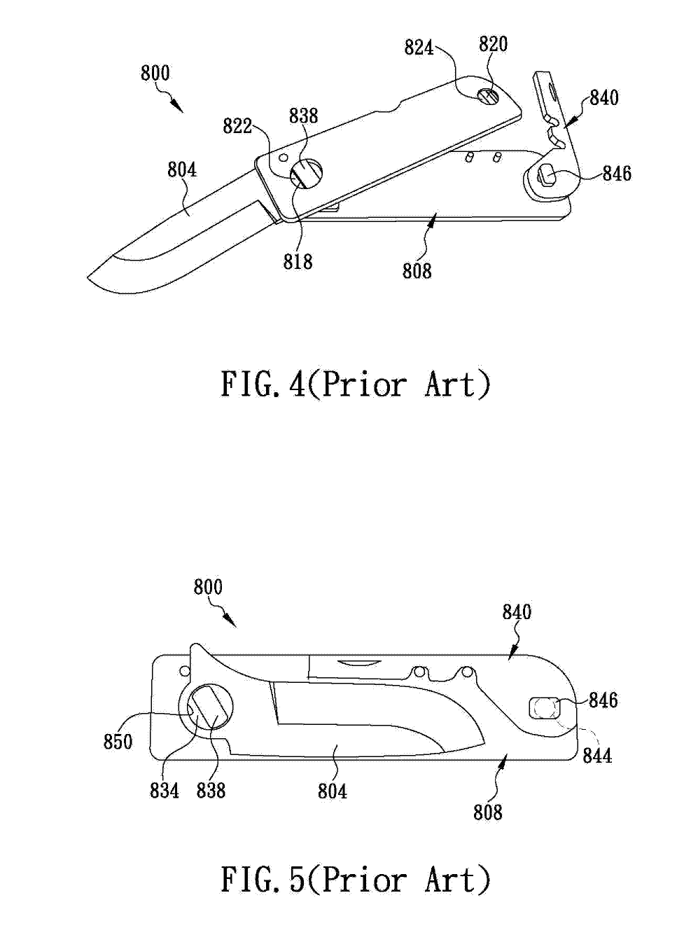

### DETAILED DESCRIPTION OF THE INVENTION

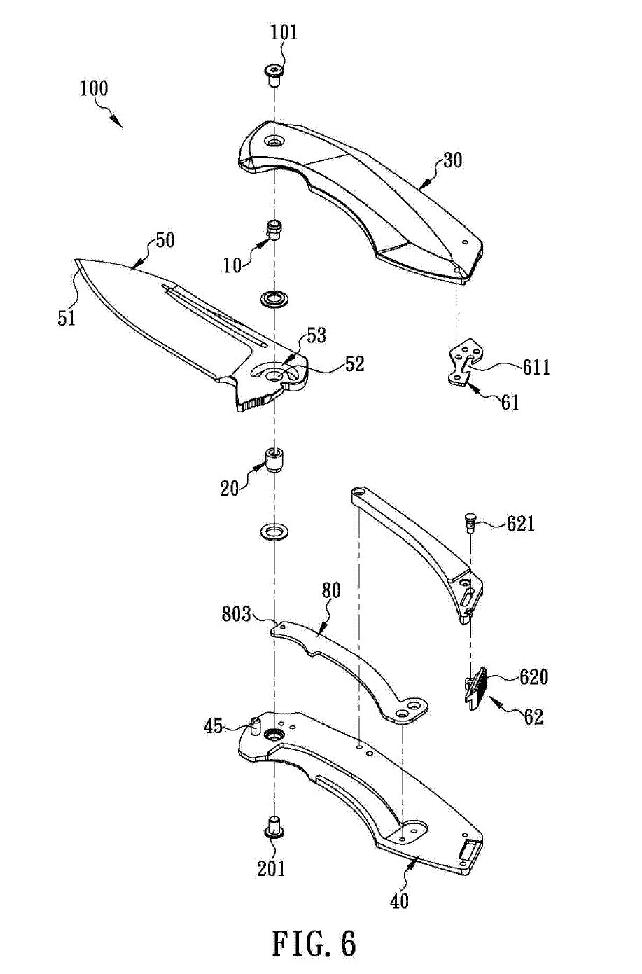

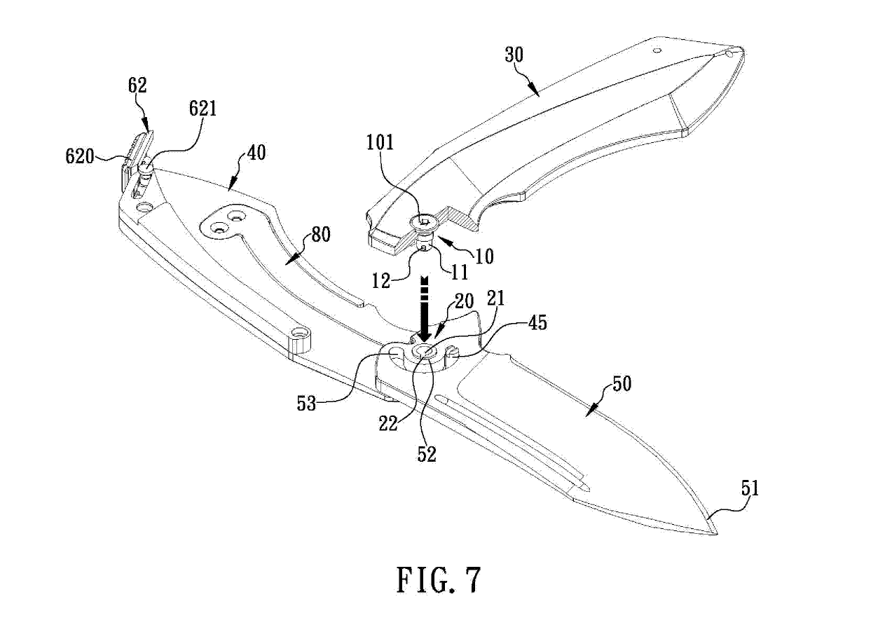

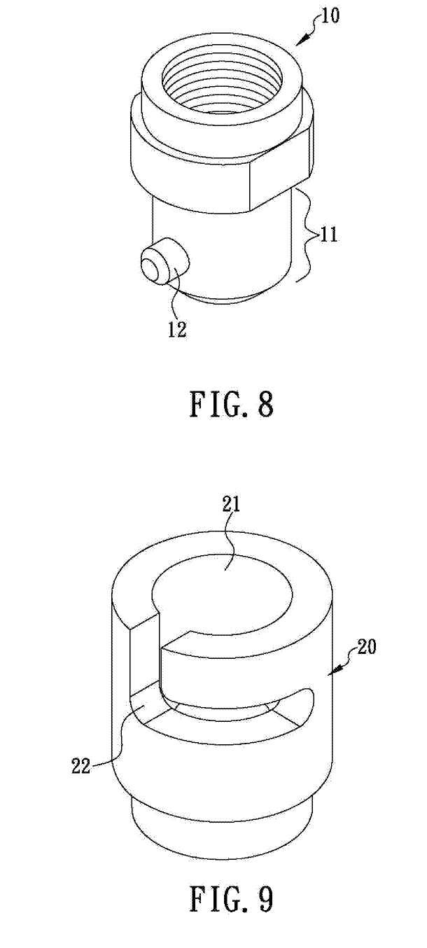

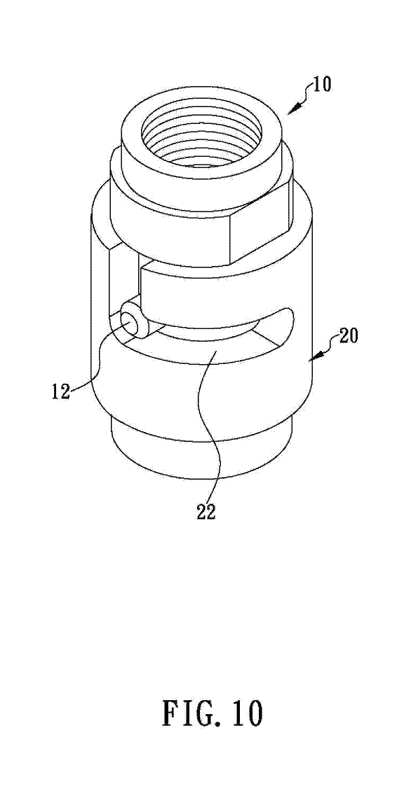

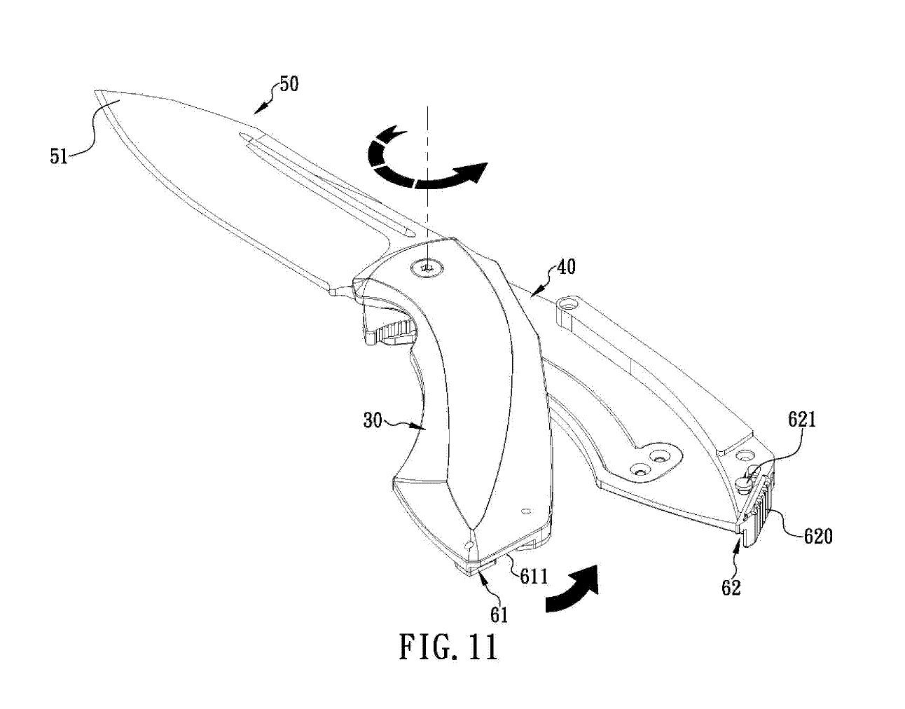

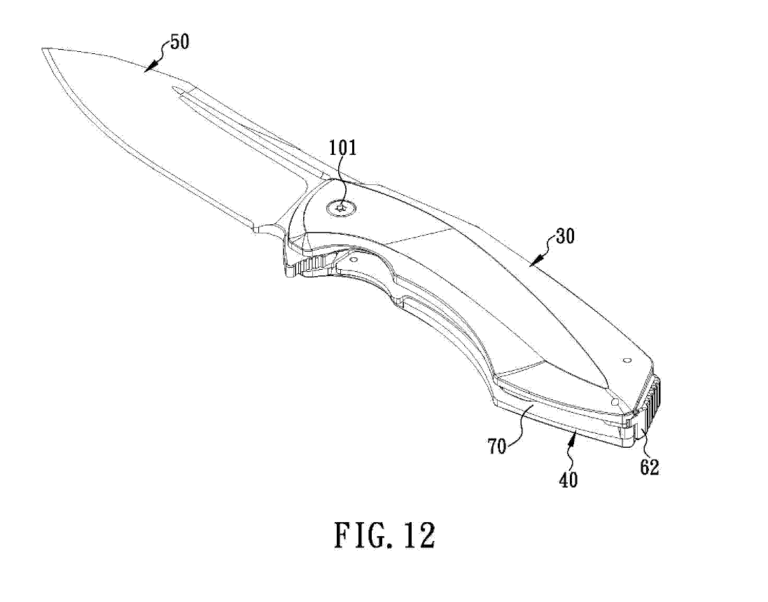

The present invention provides a folding knife configured for precise and rapid disassembly and reassembly. Referring to FIG. 6 for the first preferred embodiment of the invention, the folding knife 100 includes a first-side handle portion 30, a first pivotally connecting and engaging shaft 10, a second-side handle portion 40, a second pivotally connecting and engaging shaft 20, a blade 50, a first locking member 61, and a second locking member 62. As shown in FIG. 6 to FIG. 8, one end (hereinafter referred to as the first end) of the first pivotally connecting and engaging shaft 10 is fixed by a first bolt 101 to the inner side of the first-side handle portion 30 at a position adjacent to one end (hereinafter the first end) of the first-side handle portion 30. The opposite end (hereinafter the second end) of the first pivotally connecting and engaging shaft 10 is formed with a first pivot shaft 11 adjacent to the end edge of the second end of the first pivotally connecting and engaging shaft 10. The first pivot shaft 11 is protrudingly provided with a tenon 12 that extends in a radial direction of the first pivot shaft 11. As to the second pivotally connecting and engaging shaft 20, referring to FIG. 6 to FIG. 9, it is fixed at one end (hereinafter the first end) by a second bolt 201 to the inner side of the second-side handle portion 40 at a position not only adjacent to one end (hereinafter the first end) of the second-side handle portion 40 but also corresponding to the first pivotally connecting and engaging shaft 10. The opposite end of the second pivotally connecting and engaging shaft 20 is concavely provided with a first pivotally connecting groove 21 that extends in the axial direction of the second pivotally connecting and engaging shaft 20. The wall of the first pivotally connecting groove 21 is concavely provided with an engaging groove 22. The configuration and position of the first pivot shaft 11 and of the tenon 12 match those of the first pivotally connecting groove 21 and of the engaging groove 22 respectively so that the first pivot shaft 11 can be pivotally connected in the first pivotally connecting groove 21 (as indicated by the bold arrow in FIG. 7) and the tenon 12 can engage with the engaging groove 22 (see FIG. 10), thereby connecting together the first pivotally connecting and engaging shaft 10 and the second pivotally connecting and engaging shaft 20, allowing the first-side handle portion 30 and the second-side handle portion 40 to be rapidly and precisely assembled, as shown in FIG. 11, with a storage space 70 formed between the inner sides of the first-side handle portion 30 and of the second-side handle portion 40 (see FIG. 12). Referring back to FIG. 6 and FIG. 7, the blade 50 is formed with a blade tip 51 at one end and is formed with a pivotally connecting hole 52 adjacent to the opposite end (hereinafter the second end) of the blade 50. The configuration of the pivotally connecting hole 52 matches that of the second pivotally connecting and engaging shaft 20 so that the pivotally connecting hole 52 can be pivotably mounted around the outer periphery of the second pivotally connecting and engaging shaft 20, allowing the blade 50, the first-side handle portion 30, and the second-side handle portion 40 to be put together as a single unit, with the blade 50 rotatable with respect to the first-side handle portion 30 and the second-side handle portion 40 about an axis defined by the first pivotally connecting and engaging shaft 10 and the second pivotally connecting and engaging shaft 20. The blade 50, therefore, can be rotated into and thus stored in the storage space 70 or be rotated out of the storage space 70. The first locking member 61 is mounted on the inner side of the first-side handle portion 30 at a position adjacent to the other end (hereinafter the second end) of the first-side handle portion 30. The second locking member 62 is movably mounted on the inner side of the second-side handle portion 40 at a position adjacent to the other end (hereinafter the second end) of the second-side handle portion 40. The configuration and mounting position of the second locking member 62 match those of the first locking member 61 respectively. Once the blade 50, the first-side handle portion 30, and the second-side handle portion 40 are precisely and securely connected, the second locking member 62 can be locked to the first locking member 61. The first locking member 61 or the second locking member 62 is provided with a release button 620. The release button 620 is adjacent to the second ends, and exposed from the peripheries, of the first-side handle portion 30 and of the second-side handle portion 40. The first locking member 61 or the second locking member 62 (in particular the release button 620, which is exposed from the peripheries of the second ends of the first- and the second-side handle portions 30, 40) can be pushed to unlock the first locking member 61 and the second locking member 62 from each other, allowing the first-side handle portion 30 and the second-side handle portion 40 to be rotated with respect to each other to enable disengagement between the first pivotally connecting and engaging shaft 10 and the second pivotally connecting and engaging shaft 20 and hence rapid and complete separation between the blade 50, the first-side handle portion 30, and the second-side handle portion 40.

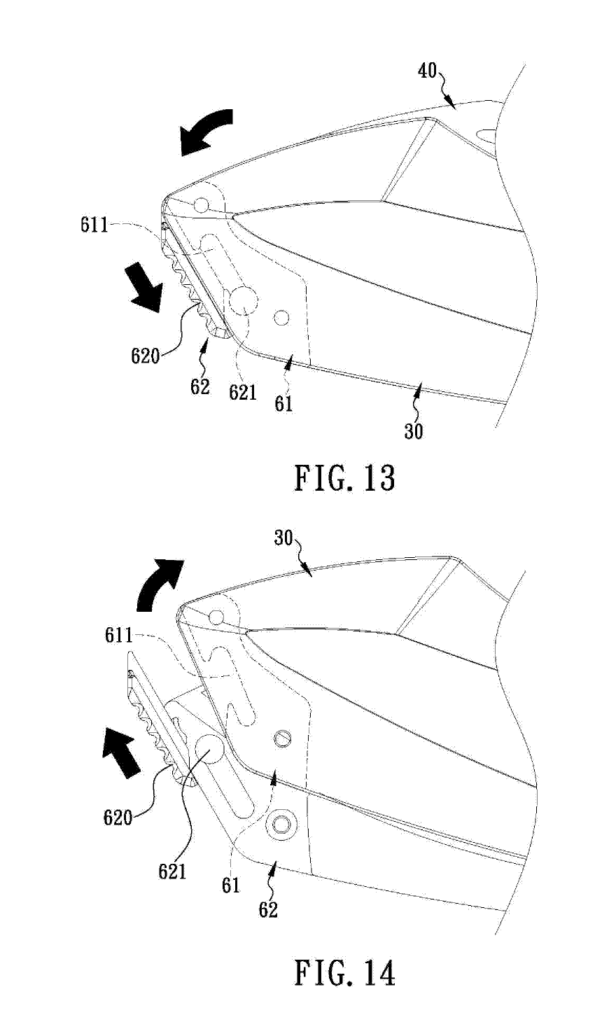

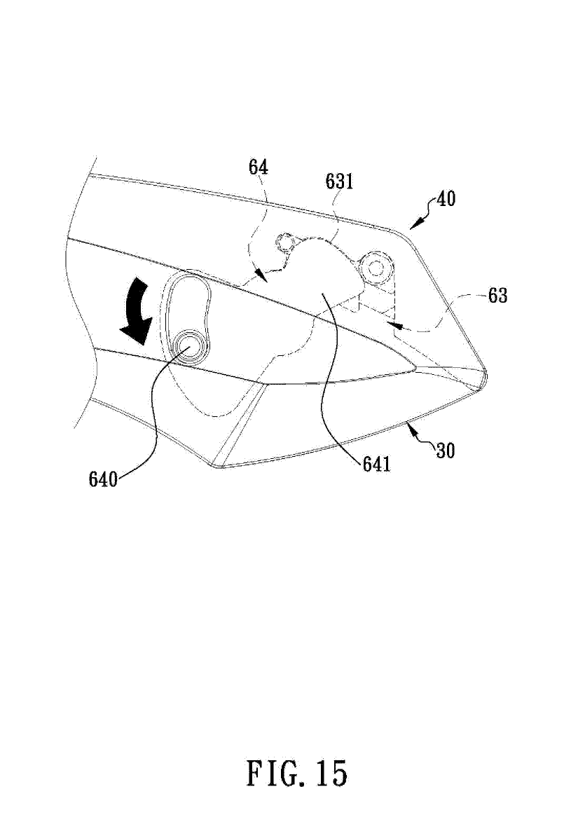

In the first preferred embodiment of the present invention, referring to FIG. 6, FIG. 7, FIG. 11, FIG. 13, and FIG. 14, the first locking member 61 is mounted on the inner side of the first-side handle portion 30, is adjacent to the second end of the first-side handle portion 30, and is provided with a locking groove 611; and the second locking member 62 is mounted on the inner side of the second-side handle portion 40, is adjacent to the second end of the second-side handle portion 40, and is provided with a movable lock 621. The configuration and mounting position of the lock 621 match those of the locking groove 611 respectively so that the lock 621 can be locked in the locking groove 611 when the first-side handle portion 30 and the second-side handle portion 40 are precisely aligned with each other and are securely connected with the blade 50 (as indicated by the rotating arrows in FIG. 11). In the first preferred embodiment, referring again to FIG. 6, FIG. 7, FIG. 11, FIG. 13, and FIG. 14, the release button 620 on the second locking member 62 is connected to the lock 621, is adjacent to the second end of the second-side handle portion 40, and is exposed from the periphery of the second-side handle portion 40 in order to be used to drive the lock 621. A user only has to push the release button 620, which is adjacent to the second end, and exposed from the periphery, of the second-side handle portion 40, and the lock 621 will be rapidly unlocked from the locking groove 611, allowing relative rotation between the first-side handle portion 30 and the second-side handle portion 40 so that the first and the second pivotally connecting and engaging shafts 10, 20 can be disengaged from each other to achieve rapid and complete separation between the blade 50, the first-side handle portion 30, and the second-side handle portion 40, in order for the user to clean, maintain, or repair the folding knife 100. Conversely, a user having put together the blade 50, the first-side handle portion 30, and the second-side handle portion 40 can push the release button 620 in the opposite direction so that the first pivotally connecting and engaging shaft 10 and the second pivotally connecting and engaging shaft 20 are tightly connected and kept from separation from each other to ensure steady use of the folding knife 100.

Referring to FIG. 6 to FIG. 14, while the first pivotally connecting and engaging shaft 10 and the second pivotally connecting and engaging shaft 20 in the first preferred embodiment of the present invention are matching elements, the two shafts are totally independent from each other in terms of manufacture. That is to say, the first pivotally connecting and engaging shaft 10 and the second pivotally connecting and engaging shaft 20 can be manufactured separately by precision machining; and once the two shafts are completed, the first end of the first pivotally connecting and engaging shaft 10 is precisely fixed by the first bolt 101 to the inner side of the first-side handle portion 30 at a position adjacent to the first end of the first-side handle portion 30, and the first end of the second pivotally connecting and engaging shaft 20 is precisely fixed by the second bolt 201 to the inner side of the second-side handle portion 40 at a position both adjacent to the first end of the second-side handle portion 40 and corresponding to the first pivotally connecting and engaging shaft 10, as shown in FIG. 6 to FIG. 9. To assemble the folding knife 100, referring to FIG. 7 to FIG. 12, a user only has to mount the pivotally connecting hole 52, which is formed in the blade 50 and adjacent to the second end of the blade 50, pivotally around the outer periphery of the second pivotally connecting and engaging shaft 20 (i.e., to insert the second pivotally connecting and engaging shaft 20, which is mounted on the inner side of the second-side handle portion 40 and adjacent to the first end of the second-side handle portion 40, through the pivotally connecting hole 52 in the blade 50) as shown in FIG. 10 to FIG. 12, and the first pivotally connecting and engaging shaft 10, which is mounted on the inner side of the first-side handle portion 30 and adjacent to the first end of the first-side handle portion 30, can be pivotally connected to and engaged with the second pivotally connecting and engaging shaft 20 with ease and precision such that the first-side handle portion 30 and the second-side handle portion 40 are precisely aligned with each other and securely connected with the blade 50 while allowing the blade 50 to be rotated into or out of the storage space 70 about the axis defined by the first pivotally connecting and engaging shaft 10 and the second pivotally connecting and engaging shaft 20. Moreover, the aforesaid components will not get loose or make noise during use.

Please note that the embodiment described above is only a preferred one of the present invention. One who tries to implement the invention may modify the foregoing embodiment according to actual production or design requirements. For example, in other embodiments of the invention, referring to FIG. 6 to FIG. 14, the first pivotally connecting and engaging shaft 10 and the second pivotally connecting and engaging shaft 20 may be integrally formed with the inner sides of the first- and the second-side handle portions 30, 40 at corresponding positions respectively, with a view to dispensing with the first bolt 101 and the second bolt 201 and thereby reducing the number of components and the steps and time required for disassembly and reassembly. Besides, the terms “first-side handle portion 30” and “second-side handle portion 40” as used herein correspond to the first pivotally connecting and engaging shaft 10 and the second pivotally connecting and engaging shaft 20 respectively; in other words, the handle portion mounted with the first pivotally connecting and engaging shaft 10 is referred to as the “first-side handle portion 30” while the handle portion mounted with the second pivotally connecting and engaging shaft 20 is referred to as the “second-side handle portion 40”.

When it is desired to disassemble the folding knife 100 for grime removal, referring back to FIG. 6 to FIG. 12, a user begins by pushing the second locking member 62 (in particular the release button 620, which is provided on the second locking member 62, adjacent to the second end of the second-side handle portion 40, and exposed from the periphery of the second-side handle portion 40) with a finger to unlock the lock 621 from the locking groove 611 rapidly. Then, by holding the first-side handle portion 30 with one hand and the second-side handle portion 40 with the other hand, the user rotates the first-side handle portion 30 and the second-side handle portion 40 with respect to each other to disengage the first pivotally connecting and engaging shaft 10 and the second pivotally connecting and engaging shaft 20 from each other so that the blade 50, the first-side handle portion 30, and the second-side handle portion 40 can be separated rapidly and completely from one another.

As stated above, the foregoing embodiment is only a preferred one of the present invention, and modifications may be made to the embodiment to meet actual production or design requirements when implementing the invention. In other embodiments of the invention, for example, the first locking member 61 may be replaced by a third locking member 63 of a different structure, and the second locking member 62, by a fourth locking member 64 of a different structure, provided that the third locking member 63 is provided on the inner side, and is adjacent to the second end, of one of the first- and the second-side handle portions 30, 40; that the fourth locking member 64 is provided on the inner side, and is adjacent to the second end, of the other of the first- and the second-side handle portions 30, 40; that the configuration of the fourth locking member 64 matches that of the third locking member 63; and that therefore after the first-side handle portion 30 and the second-side handle portion 40 are rotated about the axis defined by the first and the second pivotally connecting and engaging shafts 10, 20 to a position where the two handle portions correspond to each other, the third locking member 63 and the fourth locking member 64 can be locked together to ensure that the blade 50, the first-side handle portion 30, and the second-side handle portion 40 are precisely and securely put together.

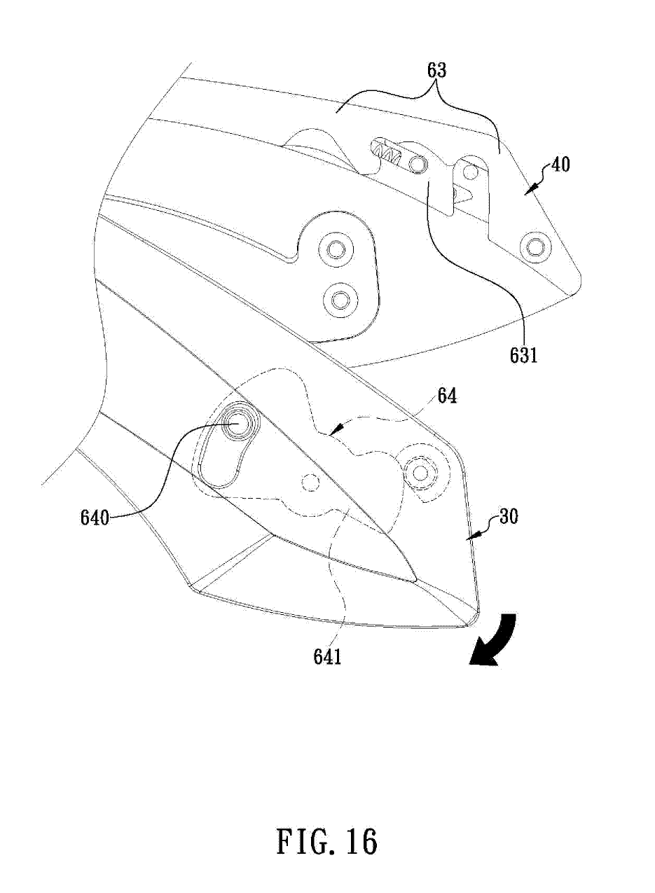

More specifically, referring to FIG. 15 and FIG. 16 for the second preferred embodiment of the present invention, the third locking member 63 is mounted on the inner side of the second-side handle portion 40, is adjacent to the second end of the second-side handle portion 40, and is provided with a locking groove 631; and the fourth locking member 64 is mounted on the inner side of the first-side handle portion 30, is adjacent to the second end of the first-side handle portion 30, and is provided with a movable lock 641. The configuration and mounting position of the lock 641 match those of the locking groove 631 respectively so that the lock 641 can be locked in the locking groove 631 when the first-side handle portion 30 and the second-side handle portion 40 are precisely aligned with each other and are securely connected with the blade 50. In the second preferred embodiment, with continued reference to FIG. 15 and FIG. 16, the fourth locking member 64 is provided with a release lever 640 connected to the lock 641. The release lever 640 has a free end exposed from an outer surface portion of the first-side handle portion 30 that is adjacent to the second end of the first-side handle portion 30 so that the lock 641 can be driven through the free end of the release lever 640. A user only has to push the free end of the release lever 640 (which free end, as stated above, is adjacent to the second end, and exposed from the outer surface, of the first-side handle portion 30), e.g., downward as indicated by the bold arrow in FIG. 15, and the lock 641 will be unlocked from the locking groove 631 rapidly, allowing the first-side handle portion 30 and the second-side handle portion 40 to be rotated with respect to each other, thereby disengaging the first pivotally connecting and engaging shaft 10 and the second pivotally connecting and engaging shaft 20 from each other so that the blade 50, the first-side handle portion 30, and the second-side handle portion 40 can be separated rapidly and completely from one another to enable cleaning, maintenance, or repair of the folding knife 100.

In another embodiment of the present invention, referring back to FIG. 6 and FIG. 7, the folding knife 100 further includes an elastic plate 80 mounted between the first-side handle portion 30 and the second-side handle portion 40. A portion of the elastic plate 80 that is adjacent to one end of the elastic plate 80 is fixed on the inner side of the second-side handle portion 40 at a position adjacent to the second end of the second-side handle portion 40, and a portion of the elastic plate 80 that is adjacent to the opposite end of the elastic plate 80 is provided with a stopping portion 803. When the blade 50 has been rotated completely out of the storage space 70, the stopping portion 803 is engaged with the second end of the blade 50 such that the blade 50 is prevented from rotation, let alone entering the storage space 70. This effectively enhances the stability and safety of the blade 50 during use. Only after the stopping portion 803 is subjected to an external force and thereby driven out of engagement with the blade 50 will the blade 50 be rotatable again and hence able to be stored into the storage space 70. It is worth mentioning that, although depicted in FIG. 6 and FIG. 7 as a plate, the stopping portion 803 may take a different form in another embodiment of the present invention. For example, the stopping portion 803 may be a protruding point while the second end of the blade 50 is provided with a recess corresponding in position to and engageable with the protruding point.

To prevent the blade 50 from excessive rotation by its user, another embodiment of the present invention features an arcuate position-limiting groove 53 and a position-limiting post 45 as shown in FIG. 6 to FIG. 7. The position-limiting groove 53 is formed in the blade 50 at a position adjacent to the second end of the blade 50. The position-limiting post 45 is protrudingly provided on the inner side of the second-side handle portion 40. In this embodiment, the free end of the position-limiting post 45 extends through the position-limiting groove 53, and the position of the position-limiting post 45 in the position-limiting groove 53 is changed in response to rotation of the blade 50. For example, the position-limiting post 45 is pressed against the wall surface of one end of the position-limiting groove 53 when the blade 50 has been rotated completely out of the storage space 70; the position-limiting post 45 is gradually moved in the position-limiting groove 53 when the blade 50 is gradually rotated into the storage space 70; and once the blade 50 is completely stored in the storage space 70, the position-limiting post 45 is pressed against the wall surface of the opposite end of the position-limiting groove 53. Therefore, by adjusting the length of the position-limiting groove 53, a manufacturer can precisely define the limits of rotation of the blade 50, ensuring that the blade 50 rotates only within a safe range and will not be rotated exceedingly by its user.

While the invention herein disclosed has been described by means of specific embodiments, numerous modifications and variations could be made thereto by those skilled in the art without departing from the scope of the invention set forth in the claims.

What is claimed is:

1. A folding knife configured for precise and rapid disassembly and reassembly, comprising:
a first-side handle portion;
a first pivotally connecting and engaging shaft having an end fixed to an inner side of the first-side handle portion at a position adjacent to a first end of the first-side handle portion, the first pivotally connecting and engaging shaft having an opposite second end formed with a first pivot shaft, wherein the first pivot shaft is adjacent to an end edge of the second end of the first pivotally connecting and engaging shaft and is protrudingly provided with a tenon extending in a radial direction of the first pivot shaft;
a second-side handle portion;
a second pivotally connecting and engaging shaft having an end fixed to an inner side of the second-side handle portion at a position not only adjacent to a first end of the second-side handle portion but also corresponding to the first pivotally connecting and engaging shaft, the second pivotally connecting and engaging shaft having an opposite end concavely provided with a first pivotally connecting groove extending in an axial direction of the second pivotally connecting and engaging shaft, wherein the first pivotally connecting groove has a wall concavely provided with an engaging groove, and the first pivot shaft and the tenon match the first pivotally connecting groove and the engaging groove respectively in configuration such that the first pivot shaft is pivotally connectable in the first pivotally connecting groove and the tenon is engageable with the engaging groove to connect the first pivotally connecting and engaging shaft with the second pivotally connecting and engaging shaft, thereby putting together the first-side handle portion and the second-side handle portion rapidly and precisely, forming a storage space between the inner side of the first-side handle portion and the inner side of the second-side handle portion;
a blade having a first end formed with a blade tip, the blade being formed with a pivotally connecting hole adjacent to an opposite second end of the blade, wherein the pivotally connecting hole matches the second pivotally connecting and engaging shaft in configuration so as to be mounted around an outer periphery of the second pivotally connecting and engaging shaft such that the blade is connected to the first-side handle portion and the second-side handle portion and is rotatable with respect to the first-side handle portion and the second-side handle portion about an axis defined by the first pivotally connecting and engaging shaft and the second pivotally connecting and engaging shaft either into or out of the storage space;
a first locking member mounted either on the inner side of the first-side handle portion at a position adjacent to an opposite second end of the first-side handle portion or on the inner side of the second-side handle portion at a position adjacent to an opposite second end of the second-side handle portion; and
a second locking member mounted either on the inner side of the second-side handle portion at a position adjacent to the second end of the second-side handle portion or on the inner side of the first-side handle portion at a position adjacent to the second end of the first-side handle portion, wherein the second locking member matches the first locking member in configuration such that, once the first-side handle portion and the second-side handle portion are aligned with each other and are securely connected with the blade, the first locking member and the second locking member are lockable together; and wherein one of the first locking member and the second locking member is configured to be pushed to unlock the first locking member and the second locking member from each other, thereby allowing the first-side handle portion and the second-side handle portion to be rotated with respect to each other to disengage the first pivotally connecting and engaging shaft and the second pivotally connecting and engaging shaft from each other so that the blade, the first-side handle portion, and the second-side handle portion are allowed to be separated rapidly and completely from one another.

2. The folding knife of claim 1, wherein the first locking member is mounted on the inner side of the first-side handle portion, is adjacent to the second end of the first-side handle portion, and is provided with a locking groove; the second locking member is mounted on the inner side of the second-side handle portion, is adjacent to the second end of the second-side handle portion, and is provided with a movable lock; and the lock matches the locking groove in configuration and position such that, once the first-side handle portion and the second-side handle portion are precisely aligned with each other and are securely connected with the blade, the lock and the locking groove are lockable together.

3. The folding knife of claim 2, wherein the second locking member is provided with a release button; the release button is connected to the lock, adjacent to the second end of the second-side handle portion, and exposed from a periphery of the second-side handle portion so as to be used to drive the lock; and a user only has to push the release button in order to unlock the lock from the locking groove, thereby allowing the first-side handle portion and the second-side handle portion to be rotated with respect to each other to disengage the first pivotally connecting and engaging shaft and the second pivotally connecting and engaging shaft from each other so that the blade, the first-side handle portion, and the second-side handle portion are allowed to be separated rapidly and completely from one another.

4. The folding knife of claim 1, wherein the first locking member is mounted on the inner side of the second-side handle portion, is adjacent to the second end of the second-side handle portion, and is provided with a locking groove; the second locking member is mounted on the inner side of the first-side handle portion, is adjacent to the second end of the first-side handle portion, and is provided with a movable lock; and the lock matches the locking groove in configuration and position such that, once the first-side handle portion and the second-side handle portion are precisely aligned with each other and are securely connected with the blade, the lock and the locking groove are lockable together.

5. The folding knife of claim 4, wherein the second locking member is provided with a release button; the release button is connected to the lock, adjacent to the second end of the first-side handle portion, and exposed from a periphery of the first-side handle portion so as to be used to drive the lock; and a user only has to push the release button in order to unlock the lock from the locking groove, thereby allowing the first-side handle portion and the second-side handle portion to be rotated with respect to each other to disengage the first pivotally connecting and engaging shaft and the second pivotally connecting and engaging shaft from each other so that the blade, the first-side handle portion, and the second-side handle portion are allowed to be separated rapidly and completely from one another.

6. The folding knife of claim 1, further comprising an elastic plate, wherein the elastic plate is mounted between the first-side handle portion and the second-side handle portion and is provided with a stopping portion; when the blade has been rotated completely out of the storage space, the stopping portion is engaged with the second end of the blade to prevent the blade from rotation and hence from entering the storage space; and the blade becomes rotatable again only after the stopping portion is disengaged from the blade by an external force.

7. The folding knife of claim 3, further comprising an elastic plate, wherein the elastic plate is mounted between the first-side handle portion and the second-side handle portion and is provided with a stopping portion; when the blade has been rotated completely out of the storage space, the stopping portion is engaged with the second end of the blade to prevent the blade from rotation and hence from entering the storage space; and the blade becomes rotatable again only after the stopping portion is disengaged from the blade by an external force.

8. The folding knife of claim 5, further comprising an elastic plate, wherein the elastic plate is mounted between the first-side handle portion and the second-side handle portion and is provided with a stopping portion; when the blade has been rotated completely out of the storage space, the stopping portion is engaged with the second end of the blade to prevent the blade from rotation and hence from entering the storage space; and the blade becomes rotatable again only after the stopping portion is disengaged from the blade by an external force.

9. The folding knife of claim 6, wherein the blade is formed with an arcuate position-limiting groove adjacent to the second end of the blade, the inner side of one of the first-side handle portion and the second-side handle portion is protrudingly provided with a position-limiting post, the position-limiting post has a free end extending through and displaceable in the position-limiting groove, the position-limiting post is pressed against a wall surface of an end of the position-limiting groove when the blade has been rotated completely out of the storage space, and the position-limiting post is pressed against a wall surface of an opposite end of the position-limiting groove when the blade is completely stored in the storage space.

10. The folding knife of claim 7, wherein the blade is formed with an arcuate position-limiting groove adjacent to the second end of the blade, the inner side of one of the first-side handle portion and the second-side handle portion is protrudingly provided with a position-limiting post, the position-limiting post has a free end extending through and displaceable in the position-limiting groove, the position-limiting post is pressed against a wall surface of an end of the position-limiting groove when the blade has been rotated completely out of the storage space, and the position-limiting post is pressed against a wall surface of an opposite end of the position-limiting groove when the blade is completely stored in the storage space.

11. The folding knife of claim 8, wherein the blade is formed with an arcuate position-limiting groove adjacent to the second end of the blade, the inner side of one of the first-side handle portion and the second-side handle portion is protrudingly provided with a position-limiting post, the position-limiting post has a free end extending through and displaceable in the position-limiting groove, the position-limiting post is pressed against a wall surface of an end of the position-limiting groove when the blade has been rotated completely out of the storage space, and the position-limiting post is pressed against a wall surface of an opposite end of the position-limiting groove when the blade is completely stored in the storage space.

12. A folding knife configured for precise and rapid disassembly and reassembly, comprising:
a first-side handle portion;
a first pivotally connecting and engaging shaft having an end fixed to an inner side of the first-side handle portion at a position adjacent to a first end of the first-side handle portion, the first pivotally connecting and engaging shaft having an opposite second end formed with a first pivot shaft, wherein the first pivot shaft is adjacent to an end edge of the second end of the first pivotally connecting and engaging shaft and is protrudingly provided with a tenon extending in a radial direction of the first pivot shaft;
a second-side handle portion;
a second pivotally connecting and engaging shaft having an end fixed to an inner side of the second-side handle portion at a position not only adjacent to a first end of the second-side handle portion but also corresponding to the first pivotally connecting and engaging shaft, the second pivotally connecting and engaging shaft having an opposite end concavely provided with a first pivotally connecting groove extending in an axial direction of the second pivotally connecting and engaging shaft, wherein the first pivotally connecting groove has a wall concavely provided with an engaging groove, and the first pivot shaft and the tenon match the first pivotally connecting groove and the engaging groove respectively in configuration such that the first pivot shaft is pivotally connectable in the first pivotally connecting groove and the tenon is engageable with the engaging groove to connect the first pivotally connecting and engaging shaft with the second pivotally connecting and engaging shaft, thereby putting together the first-side handle portion and the second-side handle portion rapidly and precisely, forming a storage space between the inner side of the first-side handle portion and the inner side of the second-side handle portion;
a blade having a first end formed with a blade tip, the blade being formed with a pivotally connecting hole adjacent to an opposite second end of the blade, wherein the pivotally connecting hole matches the second pivotally connecting and engaging shaft in configuration so as to be mounted around an outer periphery of the second pivotally connecting and engaging shaft such that the blade is connected to the first-side handle portion and the second-side handle portion and is rotatable with respect to the first-side handle portion and the second-side handle portion about an axis defined by the first pivotally connecting and engaging shaft and the second pivotally connecting and engaging shaft either into or out of the storage space;
a third locking member mounted either on the inner side of the second-side handle portion at a position adjacent to an opposite second end of the second-side handle portion or on the inner side of the first-side handle portion at a position adjacent to an opposite second end of the first-side handle portion; and
a fourth locking member mounted either on the inner side of the first-side handle portion at a position adjacent to the second end of the first-side handle portion or on the inner side of the second-side handle portion at a position adjacent to the second end of the second-side handle portion, wherein the fourth locking member matches the third locking member in configuration such that, once the first-side handle portion and the second-side handle portion are aligned with each other and are securely connected with the blade, the third locking member and the fourth locking member are lockable together; and wherein one of the third locking member and the fourth locking member is configured to be pushed to unlock the third locking member and the fourth locking member from each other, thereby allowing the first-side handle portion and the second-side handle portion to be rotated with respect to each other to disengage the first pivotally connecting and engaging shaft and the second pivotally connecting and engaging shaft from each other so that the blade, the first-side handle portion, and the second-side handle portion are allowed to be separated rapidly and completely from one another.

13. The folding knife of claim 12, wherein the third locking member is mounted on the inner side of the second-side handle portion, is adjacent to the second end of the second-side handle portion, and is provided with a locking groove; the fourth locking member is mounted on the inner side of the first-side handle portion, is adjacent to the second end of the first-side handle portion, and is provided with a movable lock; and the lock matches the locking groove in configuration and position such that, once the first-side handle portion and the second-side handle portion are precisely aligned with each other and are securely connected with the blade, the lock and the locking groove are lockable together.

14. The folding knife of claim 13, wherein the fourth locking member is provided with a release lever; the release lever is connected to the lock and has an end adjacent to the second end of the first-side handle portion and exposed from an outer surface of the first-side handle portion so as to be used to drive the lock; and a user only has to push the release lever in order to unlock the lock from the locking groove, thereby allowing the first-side handle portion and the second-side handle portion to be rotated with respect to each other to disengage the first pivotally connecting and engaging shaft and the second pivotally connecting and engaging shaft from each other so that the blade, the first-side handle portion, and the second-side handle portion are allowed to be separated rapidly and completely from one another.

15. The folding knife of claim 12, wherein the third locking member is mounted on the inner side of the first-side handle portion, is adjacent to the second end of the first-side handle portion, and is provided with a locking groove; the fourth locking member is mounted on the inner side of the second-side handle portion, is adjacent to the second end of the second-side handle portion, and is provided with a movable lock; and the lock matches the locking groove in configuration and position such that, once the first-side handle portion and the second-side handle portion are precisely aligned with each other and are securely connected with the blade, the lock and the locking groove are lockable together.

16. The folding knife of claim 15, wherein the fourth locking member is provided with a release lever; the release lever is connected to the lock, adjacent to the second end of the second-side handle portion, and exposed from an outer surface of the second-side handle portion so as to be used to drive the lock; and a user only has to push the release lever in order to unlock the lock from the locking groove, thereby allowing the first-side handle portion and the second-side handle portion to be rotated with respect to each other to disengage the first pivotally connecting and engaging shaft and the second pivotally connecting and engaging shaft from each other so that the blade, the first-side handle portion, and the second-side handle portion are allowed to be separated rapidly and completely from one another.

17. The folding knife of claim 12, further comprising an elastic plate, wherein the elastic plate is mounted between the first-side handle portion and the second-side handle portion and is provided with a stopping portion; when the blade has been rotated completely out of the storage space, the stopping portion is engaged with the second end of the blade to prevent the blade from rotation and hence from entering the storage space; and the blade becomes rotatable again only after the stopping portion is disengaged from the blade by an external force.

18. The folding knife of claim 14, further comprising an elastic plate, wherein the elastic plate is mounted between the first-side handle portion and the second-side handle portion and is provided with a stopping portion; when the blade has been rotated completely out of the storage space, the stopping portion is engaged with the second end of the blade to prevent the blade from rotation and hence from entering the storage space; and the blade becomes rotatable again only after the stopping portion is disengaged from the blade by an external force.

19. The folding knife of claim 16, further comprising an elastic plate, wherein the elastic plate is mounted between the first-side handle portion and the second-side handle portion and is provided with a stopping portion; when the blade has been rotated completely out of the storage space, the stopping portion is engaged with the second end of the blade to prevent the blade from rotation and hence from entering the storage space; and the blade becomes rotatable again only after the stopping portion is disengaged from the blade by an external force.

20. The folding knife of claim 17, wherein the blade is formed with an arcuate position-limiting groove adjacent to the second end of the blade, the inner side of one of the first-side handle portion and the second-side handle portion is protrudingly provided with a position-limiting post, the position-limiting post has a free end extending through and displaceable in the position-limiting groove, the position-limiting post is pressed against a wall surface of an end of the position-limiting groove when the blade has been rotated completely out of the storage space, and the position-limiting post is pressed against a wall surface of an opposite end of the position-limiting groove when the blade is completely stored in the storage space.

21. The folding knife of claim 18, wherein the blade is formed with an arcuate position-limiting groove adjacent to the second end of the blade, the inner side of one of the first-side handle portion and the second-side handle portion is protrudingly provided with a position-limiting post, the position-limiting post has a free end extending through and displaceable in the position-limiting groove, the position-limiting post is pressed against a wall surface of an end of the position-limiting groove when the blade has been rotated completely out of the storage space, and the position-limiting post is pressed against a wall surface of an opposite end of the position-limiting groove when the blade is completely stored in the storage space.

22. The folding knife of claim 19, wherein the blade is formed with an arcuate position-limiting groove adjacent to the second end of the blade, the inner side of one of the first-side handle portion and the second-side handle portion is protrudingly provided with a position-limiting post, the position-limiting post has a free end extending through and displaceable in the position-limiting groove, the position-limiting post is pressed against a wall surface of an end of the position-limiting groove when the blade has been rotated completely out of the storage space, and the position-limiting post is pressed against a wall surface of an opposite end of the position-limiting groove when the blade is completely stored in the storage space.
